(19) United States
(12) Patent Application Publication
(10) Pub. No.: US 2023/0209219 A1
(43) Pub. Date: Jun. 29, 2023

(54) METHOD OF REDUCING DISTURBANCE DURING CAPTURING IMAGES OF FAINT OBJECTS

(71) Applicant: Vladimir Eliich PASHKOVSKY, St. Petersburg (RU)

(72) Inventor: Vladimir Eliich PASHKOVSKY, St. Petersburg (RU)

(21) Appl. No.: 17/921,467

(22) PCT Filed: May 15, 2021
(86) PCT No.: PCT/RU2021/050131

§ 371 Date: Oct. 26, 2022

(30) Foreign Application Priority Data
May 31, 2020 (RU) 2020117852

(51) Int. Cl. H04N 25/50; G02B 23/00; G03B 7/087

(52) U.S. Cl. CPC H04N 25/50; G02B 23/00; G03B 7/087

(57) ABSTRACT

The invention relates to a field of capturing images requiring a long exposure, e.g., when faint objects are observed. The method is characterized by determination of coordinates of a field of observation and time of capturing observation results for an object to be captured, based on signals of projection by an optical system of an observation device on an array of a photo-receiving device. After that, time of presence of projections of the optical disturbance sources in the field of observation is determined, based on signals related to trajectories of the optical disturbance sources, and arriving optical signal to the array of the photo-receiving device is blocked for a time period, when the projections are resided in the field of observation during capturing the observation results. A technical effect attained by the invention is reducing effect of disturbances during imaging of faint objects.

### BACKGROUND OF THE INVENTION

### Field of Invention

The invention relates to capturing images requiring a long exposure, e.g., when faint objects are observed.

### Prior Art

Capturing images of faint objects is common, especially in astronomy. Such image capture is often inhibited by disturbances including those caused by glowing objects with known trajectory and appearance time. The glow of a low-orbit satellite due to reflection of sunlight from the surface of the satellite causes substantial deterioration of stellar sky images. The deterioration appears in form of trails of light having various widths, which are located across significant portion of a frame.

Modern telescopes used for capturing images employ photosensors, in particular those based on charge-coupled device (CCD) technology. A faint object to be captured often occupies just a portion of a field of view, i.e., the field, whose image is to be captured for the needs of a researcher or an observer. The photosensors are electronic devices characterized by integration of charge during exposure. When integration is over, the integrated charge is “zeroed”. New exposure after even a short time gap means start of charge integration process from an initial level, therefore operations of photosensors should not be interrupted during the entire exposure.

A device for capturing long-exposure images disclosed in patent RU 2717252, published on Mar. 19, 2020, is intended for protecting images of faint objects against bright disturbances. In particular, this device allows capturing stellar sky images with long exposure times under conditions of short-time optical disturbances caused by low-orbit satellites. The corresponding method includes use of a secondary shutter that interrupts arriving an optical signal to a photo sensor during presence of a disturbance in the field of view upon demand by a disturbance detector. One drawback of this method is that the interruption of arriving an optical signal to the photo sensor substantially reduces exposure time, when the disturbance appears in the field of view for a long time. Thus, little time remains available for actual imaging faint objects. Another drawback of this method is that it includes full interruption of imaging, i.e., a light energy flow directed to the photo receiver is blocked entirely. Therefore, it interferes with capturing short-time events, which may be not affected by the disturbance and may be of interest for an observer.

### SUMMARY OF THE INVENTION

A technical result of the invention is reducing effect of disturbances during capturing images of faint objects.

A method of reducing effect of disturbances during capturing images of faint objects includes determination of coordinates of the field of observation and time of capturing observation results for the object to be captured, based on signals of projection by the optical system of the observation device on the array of photo-receiving device. After that, time of presence of projections of the optical disturbance sources in the field of observation is determined, based on signals related to trajectories of the optical disturbance sources, and arriving optical signal to the array of photo-receiving device is blocked for a time period, when the projections are in the field of observation during capturing the observation results.

The concept includes interruption (partial or entire) of action of optical signal upon the array of photo-receiving device for exact time, when the optical disturbance source is in the field of view near the faint object. If the disturbance source is in the field of view but it does not impede capturing the faint object, then arrival of the optical signal to the array is not interrupted. Thus, the following main objective is achieved: time of capturing image of a faint object is not interrupted or it is interrupted to a lesser extent, so more images of such objects are obtained with appropriate quality thereof.

In particular, the optical disturbance sources may be artificial objects like satellites.

In addition, the optical disturbance sources may be natural objects like meteors.

An optical shutter may be used as the device for blocking arrival of optical signal from the telescope to the array of photo-receiving device.

Arrival of optical signal to the array of photo-receiving device may be interrupted, inter alia, by using control system intended for the array of photo-receiving device.

An absorbing optical filter may be used as the device for blocking arrival of optical signal from the telescope to the array of photo-receiving device.

An optical reflection device may be used as the device for blocking arrival of optical signal to the array of photo-receiving device.

An optical deflection device may be used as the device for blocking arrival of optical signal to the array of photo-receiving device.

### Terms and Definitions Used in this Text

An array of photo-receiving device is formed by one or more photosensors, which provide capturing optical signal arriving from an optical system to the photo-receiving device.

Field of image capture is a projection by the optical system of the observation device onto the array of photo-receiving device at a particular time of observation.

Field of observation is a portion of the array of photo-receiving device, where a projection of the faint object to be captured is located at a particular time of observation.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED DRAWINGS

The accompanying drawings, which are incorporated into and form a part of the specification, illustrate the practice of embodiments of the present invention and, together with the description, serve to explain the principles of the invention. The drawings are only for the purpose of illustrating certain embodiments of the invention and are not to be construed as limiting the invention.

In the figures:

FIG. 1 shows a schematic diagram illustrating interaction of equipment during carrying out the method.

FIG. 2 shows the field of image capture (5) with presence of disturbance in the field of observation (6).

FIG. 3 shows the field of image capture (5) without disturbance in the field of observation (6).

FIG. 4 shows temporal diagrams of operations according to the method.

### DETAILED DESCRIPTION OF EMBODIMENTS OF THE INVENTION

Reference will now be made in detail to the preferred embodiments of the present invention, examples of which are illustrated in the accompanying drawings.

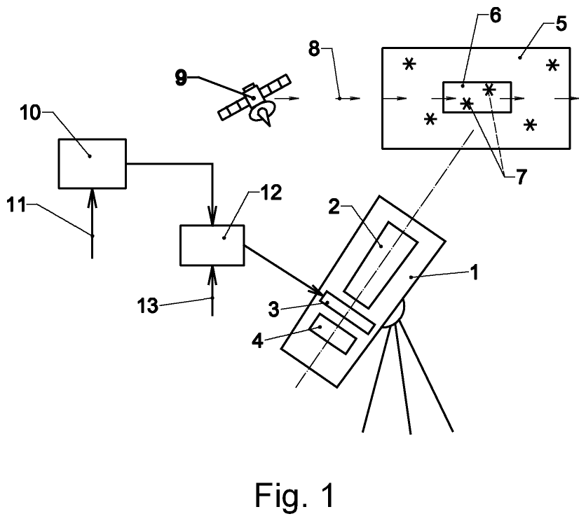

FIG. 1 shows a schematic diagram for a system embodiment implementing a method of reducing effect of disturbances, when images of faint objects are captured during astronomic observations. An observation device (1), which is a telescope in this case, includes an optical system (2), a device for blocking optical signal (3), which also may be referred to as a shutter (3), and an array (4) of photo-receiving device. The observation device (1) has a field of image capture (5) during observation.

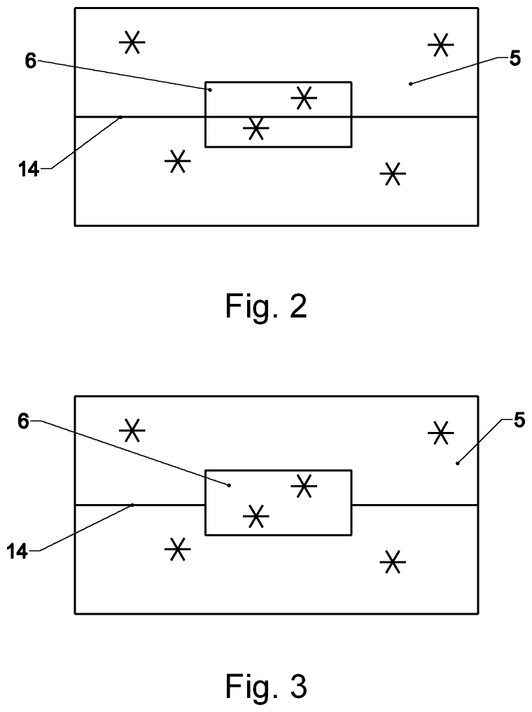

The field of image capture (5) includes a field of observation (6), i.e., a portion of the array of photo-receiving device, where projection of faint object(s) (7) to be captured is located during observation (see FIG. 2 and FIG. 3).

The field of observation (6) is shown as a rectangular in FIG. 2 and FIG. 3. In practice, it may have any shape. FIG. 1 shows a trajectory (8) of disturbance motion. In this case, the disturbance is a satellite (9). Satellites, meteors and other objects may be considered as disturbances.

A portion of the system intended for determination of parameters characterizing residence of projections of optical disturbance sources in the field of observation (6) includes a prediction unit (10) for predicting disturbance trajectories and a control unit (12) for controlling the shutter (3).

Signals containing information on spatial trajectory parameters of disturbances enter input (11) of the prediction unit (10). A signal containing trajectory parameters of disturbances in the field of view of the observation device (1) is fed from output of the prediction unit (10) to input of the control unit (12). Signals containing parameters of borders of the field of image capture (5), borders of the field of observation (6) and timing data of starting and finishing registration of observation results enter input (13) of the control unit (12).

An optical device shutter or an additional device, e.g., a secondary shutter, diaphragm or absorbing filter may be used as the device (3) for blocking optical signal. The shutter, as well as the secondary shutter, interrupts the optical signal entirely, thus interrupting disturbance action. The absorbing filter, as well as the diaphragm, attenuates the optical signal to a level that allows removing disturbances from images by computer processing methods. Arrival of the optical signal to the array of photo-receiving device may also be blocked by a system for controlling the array.

The method is carried out as follows.

Initially, an exact portion of the celestial sphere is determined to be the observation aim at a certain time of observation, based on signals entering input (13) of the control unit (12). In other words, the field (5) of image capture is determined (see FIG. 1 to FIG. 3), which is a projection by the optical system of the observation device (1) onto the array of photo-receiving device.

Time of start and finish of observation results registration is determined using signals entering input (13) of the control unit (12). Coordinates of the field of observation (6) are also determined using signals entering input (13) of the control unit (12), where the field of observation (6) contains a faint object (7) projection at a certain time of observation.

Residence time and trajectory of disturbance sources within the field of view of the observation device (1) are determined using the disturbance trajectory prediction unit (10), based on the signals on spatial trajectories of disturbance sources. For example, signals on trajectories of satellites may be received from NORAD database (www.space-track.org), or from other similar databases like databases of Space Situation Awareness services, or from devices for tracking satellite trajectories. In addition to data on satellites as glowing objects, data on trajectories of meteors and other disturbances received from disturbance detection devices may be used.

Trajectories of satellites within the field of view of the observation device (1) at a predetermined time are calculated in the disturbance trajectory prediction unit (10). For example, when the calculation is done based on trajectory parameters obtained from NORAD database, the calculation may use mathematical model SGP4. The model calculates positions of satellites in Earth Centered Inertial (ECI) Coordinate System. Further, as a possible option, the calculation data may be transformed to parameters RA (Right ascension) and DEC (Declination) of Equatorial coordinate system, taking into account telescope position and other parameters.

After that, a signal with parameters of trajectories of satellites within the field of view is fed from output of the prediction unit (10) to input of the control unit (12). Here, parameters of trajectory projections onto the field of image capture (5) are determined, based on the parameters of the trajectories of satellites. Additionally, time points when satellite trajectory projections cross borders of the field of image capture (5) and the field of observation (6) are calculated in the control unit (12). Further, parameters corresponding the predetermined observation time are extracted from the calculation results. These parameters are sorted by time and, in form of a control signal, are fed from output of the control unit (12) to the device (3) for blocking optical signal, i.e., to the shutter (3).

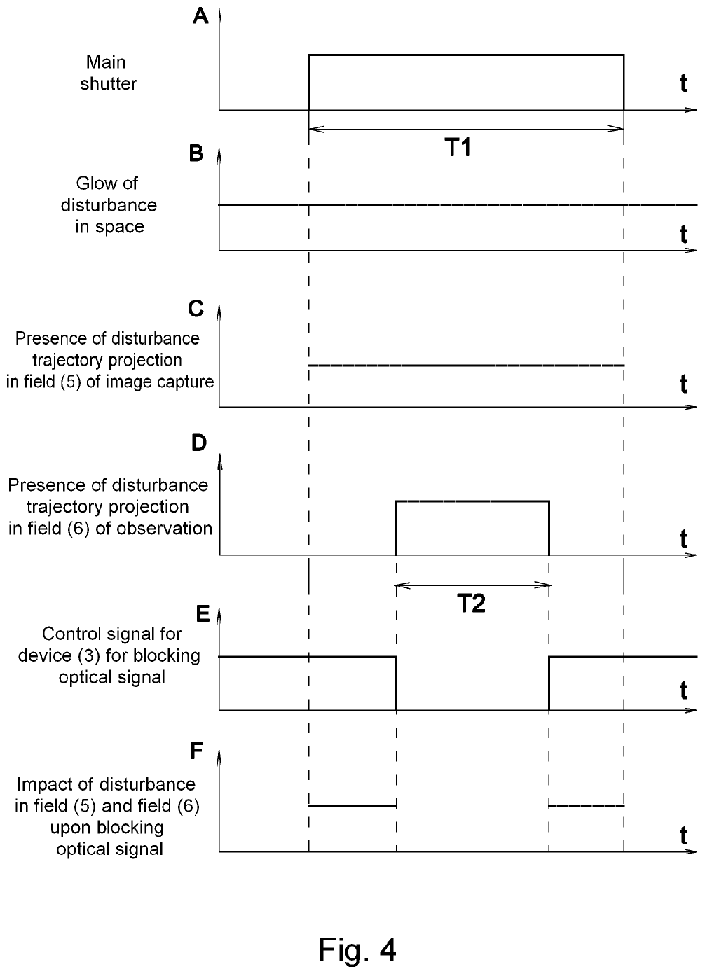

Attenuation of action of the optical signal on the array (4) of photo-receiving device, when a disturbance projection resides within the field of observation (6), is provided as follows (see FIG. 4). The main shutter of the observation device (1) is open during time period T1 that is capture time for the faint objects (7) (see Plot A). This time may be of tens, hundreds or thousands of seconds. Plot B in FIG. 4 shows that, during time period T1, projection of the satellite (see FIG. 1), which glow causes disturbance, may reside within the field of image capture (5), including the field of observation (6). The disturbance trajectory projection (14) onto the field of image capture (5) and the field of observation (6) is shown in FIG. 2. Presence of the disturbance trajectory projection (14) onto the field of image capture (5) is illustrated by Plot C in FIG. 4. Time of presence of the disturbance projection in the field of observation (6) is shown by Plot D in FIG. 4, where it is designated as time period T2.

Effect of disturbance on capturing faint objects (7) is reduced by the device (3) for blocking optical signal, which is provided for time period T2 only, when the disturbance trajectory projection (14) resides in the field of observation (6) (see Plot D in FIG. 4). The blocking is done by demand of the control signal coming from output of the control unit (12) to the device (3) for blocking optical signal. Timing diagram of the control signal is represented by Plot E in FIG. 4.

The blocking is assured by interruption of an optical signal by a shutter. In this case, as shown by Plot F in FIG. 4, the disturbance trajectory projection (14) is absent in the field (6) of observation.

When a disturbance appears in the field of image capture (5) beyond the field of observation (6), the optical signal is not blocked. This approach allows using this time for receiving useful optical signal entirely, which ensures proper quality of captured images of objects in the field of observation (6).

Blocking optical signal by demand of the control signal during time period T2 may also be done using an absorbing optical filter. Such a filter reduces effect of disturbance to a level specified by the observer. Blocking optical signal by demand of the control signal for time period T2 may also be done using a diaphragm. Use of the diaphragm also provides reduction of effect of disturbance to a level specified by the observer. In particular, this effect may be reduced to a level that prevents transition of pixels of the array (4) to saturation mode. In this case, the disturbance further may be fully removed from the image by computer processing methods.

When capturing is complete and objects image of a proper quality is obtained in the field of observation (6), another portion of the field of image capture (5) may be selected as a next field of observation (6), if applicable, automatically or manually by operator. Afterwards, the entire sequence of above-described steps is performed for image capturing in the next field of observation (6).

Thus, quality images may be obtained for certain portions of the field of image capture (5) under conditions of continuous influence of disturbances, so as image for the entire field of image capture (5) (or a substantial area thereof) may further be formed by combining the partial images, if applicable.

### INDUSTRIAL APPLICABILITY

The method of reducing effect of disturbances during capturing images of faint objects may be effectively used in astronomy, first of all, in existing observation systems.

It should also be appreciated that various modifications, adaptations and alternative embodiments thereof may be made within the scope and spirit of the present invention. The invention is further defined by the following claims. The entire disclosures of all patents and publications cited above are hereby incorporated by reference.

What is claimed is:

1. A method of reducing effect of disturbances during capturing images of faint objects, wherein:
determining coordinates of a field of observation and time of capturing observation results for the object to be captured, based on signals related to a projection by an optical system of an observation device on an array of photo-receiving device;
determining time of presence of projections of optical disturbance sources in the field of observation, based on signals related to trajectories of the optical disturbance sources; and
blocking arrival of optical signal to the array of photo-receiving device for a time period, when these projections are in the field of observation during capturing the observation results.

2. The method of claim 1, wherein the disturbance sources are artificial satellites.

3. The method of claim 1, wherein the disturbance sources are meteors.

4. The method of claim 1, wherein the blocking of the arrival of the optical signal to the array is provided by an optical shutter.

5. The method of claim 1, wherein the blocking of the arrival of the optical signal to the array is provided using a control system for the array of photo-receiving device.

6. The method of claim 1, wherein the blocking of the arrival of the optical signal to the array is provided by an absorbing optical filter.

7. The method of claim 1, wherein the blocking of the arrival of the optical signal to the array is provided by an optical reflection device.

8. The method of claim 1, wherein the blocking of the arrival of the optical signal to the array is provided by an optical deflection device.
